(19) United States
(12) Patent Application Publication
(10) Pub. No.: US 2008/0178567 A1
(43) Pub. Date: Jul. 31, 2008

(54) Dust screens on hyrdonic or electric baseboard heating units

(76) Inventors: Anthony Varrichio, West Islip, NY (US); James Feeney, Nesconset, NY (US)

Correspondence Address: Anthony J. Varrichio, 50 Skipper Drive, West Islip, NY, 11795, US

(21) Appl. No.: 11/627,944

(22) Filed: Jan. 26, 2007

(51) Int. Cl. B01D 39/00

(52) U.S. Cl. 55/495

(57) ABSTRACT

A base board heater having a dust screen or dust filter, located upstream of the heat convection inducing heat exchanger unit, captures the airborne dust particles prior to their entrance into the heat unit chamber where the heat exchanger is located.

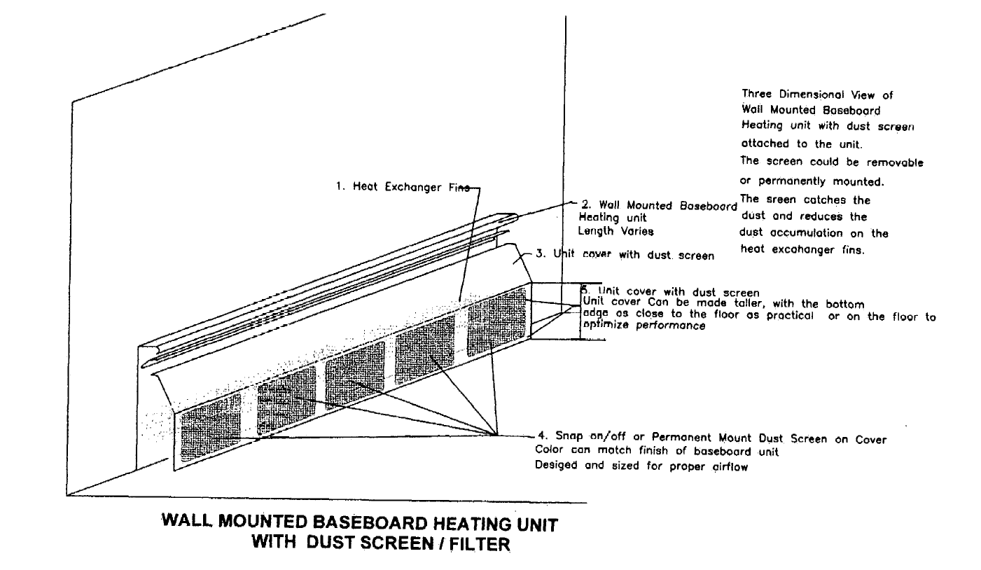

The use of a dust screen so located, protects the heat exchanger from the dust particles, preventing dust buildup and accumulation, and dust particle distribution into the atmosphere of the room.

Multiple benefits are obtained as a result:
The heat exchanger need not be cleaned
Dust particle distribution into the atmosphere is minimized or eliminated
Appearance of the base board heating unit is improved as a result of eliminating the frequent disassembly and reassembly of the unit after attempted cleaning
Ease of dust particle removal from the screens

### TECHNICAL FIELD AND INDUSTRIAL APPLICABILITY OF THE INVENTION

This invention relates to the manufacture and fabrication of front covers, with built in or removable screens, for any generic baseboard heating unit either currently manufactured and or in use in any habitable structure; or any baseboard heating unit to be manufactured in the future.

### BACKGROUND OF THE INVENTION

Baseboard heating units, heat an area/room using the principle of convection heating. These units are typically installed along the base of the wall at the floor to heat a room; therefore the general name: base board heating unit.

Typically, an energy source of heat is used to heat an element or heat exchanger within the baseboard unit. (The source of heat could be an electric resistance heating element or a hot water conveying pipe with very thin metal fins spaced close together)
The heated element heats the air within the unit causing this heated air to rise while cooler air along the floor is drawn into the unit thus replacing the risen heated air.
The heated air rises and propagates up and along the upper regions of the room and as the room is heated, the air cools and returns to the floor where it is drawn back to the heating unit thus repeating the cycle.
(HYDRONIC means the heat source is heated water flowing through a pipe)

The hydronic unit's heat exchanger, typically composed of a copper pipe, surrounded by very thin aluminum or tin sheets (fins) placed closely together, a pre determined distance, to effectively and efficiently transfer the heat from the flowing hot water in the pipe, collects dust as the air passes through and around the heat exchanger fins as the air is heated.

This dust collects on the heat exchanger fins and pipe over time, and if the dust is not removed, is re-circulated throughout the room. With time, the dust accumulates to the point where it is visible, unsightly and unsanitary, and must be removed.

The current cleaning process involves the removal of the baseboard unit cover, and brushing, or wiping, or vacuuming the dust in the narrow spaces between the fins of the heat exchanger.

The unit must then be reassembled by replacing the cover which often times is not done correctly and then the heating units in the room appear untidy, sloppy, and improperly assembled or installed. The added problem is the accumulation and recirculation of dust throughout the room which causes problems to individuals with allergies, and other respiratory ailments.

The solution to the problem is the incorporation of a dust screen into the upstream side of the heating unit, typically placed on the face or the bottom of the heating unit

### BRIEF DESCRIPTION OF DRAWING

Attached Drawing # 01-23-07, and 01-23-2, are isometric views of the baseboard heater unit illustrating the screens in their position an the face plate of the heater unit in a varied pattern that can be used to suite individual taste and or preference. Note the screen is on the upstream air flow side of the heat exchanger where it will perform its function of trapping airborne dust particles prior to the air entering the heat exchange area. Reference Drawing # 01-23-07 and #01-23-02
1. Heat Exchanger Fins: Typical of all baseboard heater units where dust is collected without screens
2. Wall mounted section of a typical baseboard heating unit
3. Unit Cover or front face of the unit with dust screens
4. Snap on/off or permanently mounted dust screens on the cover. Color can match the finish of the unit. The screens are to be sized for optimum operation and airflow
5. The Unit Cover height can be made large enough for the bottom edge to be as close to the floor surface as possible. This will allow the convection air currents to flow through the primary path which is through the screens.
   The two referenced isometric drawings mentioned supra show the possibility of various screen geometric patterns. Screens as shown are rectangular and hexagonal, however any geometric pattern can be used to individual taste.

What is claimed is:

1. A built-in screen, or, attachable and removable screen, on the front cover attachment of the baseboard heating unit, to catch the dust, that is easily cleaned without the need to remove the front cover attachment to clean the heating unit of the collected dust. (SEE Attached drawing # 01-23-07-1, #01-23-07-2
Clean the baseboard unit more frequently at regular intervals. The way to accomplish this task easily and efficiently is by the addition or incorporation of a dust catching screen which is easily accessible for cleaning by use of a vacuum cleaner.
This new design idea incorporates the baseboard heating unit with a removable or fixed screen that is located at the floor level of the unit, or on the Unit cover as illustrated on the accompanying drawing.
The incoming cool air from the floor flows through the screen which filters the dust out of the air. The screen holds the dust and reduces and or prevents the dust from accumulating on the heat exchanger, and re-circulating the dust back into the room.
This idea allows cleaning the easily accessible screen at regular intervals thus reducing and eliminating
Dust accumulation on the inner core of the heating unit
Dust distribution within the room
An alternate method is locating the screen at the output side or the hot air side of the unit The screen will catch the dust as the hot air passes through the screen; however without the “upstream” screen, the heat exchanger's fins will retain much of the dust and will eventually get dirty from the accumulated dust.
The purpose of the idea is to reduce and or eliminate the dust accumulation within the heating unit, and the reduction of dust recirculation in a room.
